(19) United States
(12) Patent Application Publication
(10) Pub. No.: US 2022/0108341 A1
(43) Pub. Date: Apr. 7, 2022

(54) MOBILE APPLICATION FOR VEHICLE SERVICE OFFERS

(71) Applicant: AnnMarie Rose Zoto, ORMOND BEACH, FL (US)

(72) Inventor: AnnMarie Rose Zoto, ORMOND BEACH, FL (US)

(21) Appl. No.: 17/411,283

(22) Filed: Aug. 25, 2021

Related U.S. Application Data
(60) Provisional application No. 63/088,229, filed on Oct. 6, 2020.

(51) Int. Cl. G06Q 30/02; G06Q 10/00; G06Q 10/10; G06Q 40/02; G06F 16/9535

(52) U.S. Cl. CPC G06Q 30/0222; G06Q 10/20; G06Q 10/1093; G06Q 30/016; G06Q 40/02; G06F 16/9535; G06Q 30/0235

(57) ABSTRACT

A computer-implemented method is provided, including providing, by the computing device, an electronic marketplace for a plurality of offers to perform at least one vehicle service, the plurality of offers being provided by different vehicle service providers; receiving, by the computing device, user-input information about at least one vehicle associated with a user; associating the information about the at least one vehicle to a user account associated with the electronic marketplace for the user; accessing at least one database associated with the electronic marketplace, the database storing information about the plurality of offers to perform the at least one vehicle service, the at least one vehicle service including at least one of a vehicle repair service and a vehicle maintenance service; using at least a portion of the user-input information about the at least one vehicle associated with the user to select at least one offer out of the plurality of offers stored at the database; and providing, by the computing device, information about the at least one offer to a client device associated with the user.

### CROSS-REFERENCE DATA

The present application claims a priority date benefit from a US Provisional Patent Application No. 63/088,229 filed Oct. 14, 2020 with the same title, which is incorporated herein by reference in its entirety.

### FIELD OF THE INVENTION

The present invention relates generally to vehicle services, and more particularly, to a system and method for vehicle service offers.

### BACKAROUND OF THE INVENTION

Conventional arrangements for consumers to find deals to have their vehicles serviced (e.g., oil change, alignments, tire rotation, repair, maintenance, etc.) include performing a general Internet search for service providers, such as vehicle manufacturer dealers or third party independent vehicle service providers, such as Jiffy Lube. However, the information available to consumers searching on the Internet can be very challenging to narrow down in order to be relevant to the particular vehicle service the consumer is searching for, to locate a service provider that is qualified to service their particular vehicle type and/or to identify deals, specials or coupons that suit a consumer's financial constraints. Performing such a search can take a consumer down an electronic rabbit whole of random service providers, various non-suitable deals and can unfortunately consume more tittle than desired to search for deals.

To avoid such a search or to otherwise streamline the consumer's time, many consumers opt to have their vehicles services by a vehicle dealership that includes a service department that can service vehicles that are manufactured by a vehicle manufacturer associated with the vehicle dealership. However, dealership prices for performing maintenance and repair on vehicles is generally fairly costly, as compared to other available service providers. Also, dealerships may run deals or specials that may only be available during a limited time, which the consumer may not become aware of in time to take advantage of the deal. Thus, consumers may miss an opportunity to have their vehicle serviced at a reduced cost. Accordingly, there is an established need for a solution to the aforementioned problems.

### SUMMARY OF THE INVENTION

Some embodiments of the present invention are directed to a mobile application (or other software application) facilitating a search for vehicle services. In some embodiments, a user signs into the mobile application, inputs vehicle information and, based on the vehicle information, the mobile application and/or the server filters the offers (e.g., specials, deals, coupons, etc.) for the vehicle services (e.g., repairs, maintenance, etc.) that relates to the consumer's vehicle(s). Some embodiments of the present invention filter out offers (e.g., specials, deals, coupons, etc.) for the vehicle services that do not apply to the consumer's particular vehicle or vehicles.

Some embodiments may advantageously save a user's time, effort and misunderstanding of offers (e.g., specials, deals, coupons, etc.) that do not apply to the user's particular vehicle. In some embodiments, a user signs into a mobile or other software application, provides a name and optionally a profile picture and then a user account is created. The user may then provide information about each of the user's one or more vehicles, such as, for example, a make, a model, a year, an oil type and optionally, a vehicle identification number (VIN) and additional notes. In some embodiments, once the vehicle information is entered by the user and added to the user's account information or profile, the user may select one of his/her vehicles (e.g., using checkbox) vehicles to be able to view what particular offers (e.g., specials, deals, coupons, etc.) are active for maintenance, service, repairs for that vehicle by, for example, selecting a “deals” tab on the mobile application on his/her mobile device.

In some embodiments, information about the offers is entered or otherwise provided by service providers on the backend.

Some embodiments of the present disclosure may provide a system and method that selects services, maintenance, repairs, etc. for a specific vehicle that the user desires to view and consider.

In a first implementation of the invention, a computer-implemented method, which may be implemented by one or more processors in a computing device/electronic device, is provided. The method comprises one or more of:

providing, by the computing device, an electronic marketplace for a plurality of offers to perform at least one vehicle service, the plurality of offers being provided by different vehicle service providers;

receiving, by the computing device, user-input information about at least one vehicle associated with a user;

associating the information about the at least one vehicle to a user account associated with the electronic marketplace for the user;

accessing at least one database associated with the electronic marketplace, the database storing information about the plurality of offers to perform the at least one vehicle service, the at least one vehicle service including at least one of a vehicle repair service and/or a vehicle maintenance service;

using at least a portion of the user-input information about the at least one vehicle associated with the user to select at least one offer out of the plurality of offers stored at the database; and

providing, by the computing device, information about the selected at least one offer to an electronic device associated with the user.

In another implementation of the invention, using the at least the portion of the user-input information comprises filtering the plurality of offers stored at the database based on the at least the portion of the user-input information.

In another implementation of the invention, using the at least the portion of the user-input information comprises selecting the at least one offer out of the plurality of offers stored at the databased based on a subset of the user-input information, the subset being selected by the user.

In another implementation of the invention, the method further comprises providing, via the electronic marketplace, a first account type associated with a first group of users and a second account type associated with a second group of users. The first group of users comprising users requesting to be provided with offers according to the at least one vehicle associated with the user. The second group of users comprising users associated with vehicle service providers requesting offer information to be presented to the first group of users. The first group of users are different from the second group of users.

In another implementation of the invention, the electronic marketplace is associated with a mobile application. In another implementation, the electronic marketplace is associated with a first mobile application type corresponding to the firs(group of users and a second mobile application type corresponding to the second group of users. In another implementation of the invention, the electronic marketplace is associated with a mobile application, a web-based electronic interface, a desktop application, a cloud-based software service and/or any other software application.

In another implementation of the invention, the plurality of different service providers including at least one service provider associated with a vehicle manufacturer dealer service center and at least one third-party vehicle service provider. The at least one service provider associated with the vehicle manufacturer is independent from the at least one third-party vehicle service provider.

In another implementation of the invention, the method includes receiving, by the computing device, provider-input information from a client device associated with a first vehicle service provider. The provider-input information includes offer information provided by the first vehicle service provider. In another implementation, the method includes storing, by the computing device, the provider-input information in at least one database associated with the electronic marketplace. The database may store all the offer information from the plurality of different vehicle service providers. One, some, or all service providers may have an option to enter their regular list of vehicle services (without an expiration date) as well as enter their special offers and discounts, that may apply only to some and not all consumers, and may have certain expiration times.

In another implementation of the invention, the method includes providing a predetermined list of offers. The predetermined list may be provided by a service provider via a mobile application, which is viewable by the consumer. The list of offers may be a drop-down menu that is selectable by a suitable consumer that is matched with vehicle service providers based on his/her vehicle. In another implementation of the invention, the method includes providing a predetermined list of vehicles. The predetermined list of vehicle information may be provided via a mobile application and is selectable by a user in the first group of users associated with vehicle owners. In another implementation, the predetermined list of offers from service providers may be matched with the predetermined list of vehicles for one or more consumers. In yet another implementation, at least a part of the predetermined list of offers may be matched with at least one of several vehicles from the predetermined list of vehicles. In further embodiments, if a certain vehicle service is scheduled for a certain day, entry of a better offer for a vehicle service by a service provider may be used to automatically generate an alert to the consumer that a better deal is available prior to their scheduled day of service.

In another implementation of the invention, the offer information includes at least one term of the offer. In another implementation, the offer information includes at least one of: information indicating a name of the vehicle service provider, a cost for the vehicle service, a time limitation associated with the offer, a code associated with redeeming the offer with the vehicle service provider, a physical address and contact information associated with the vehicle service provider.

In another implementation of the invention, using the at least a portion of the user input information to select the at least one offer out of the plurality of offers stored at the database includes matching provider-input offer information to user-input vehicle information. In another implementation of the invention, using the at least a portion of the user-input information to select the at least one offer out of the plurality of offers stored at the database includes selecting the at least one offer comprising offer information that includes at least one user-input vehicle information.

In another implementation of the invention, the information about the selected offers is provided to the client device in at least one of a geographical map view and a list view.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a block diagram of an exemplary electronic computing device (e.g., client device, computing device/server, service provider device, etc.), in accordance with an embodiment of the present invention;

FIG. 2 presents a block diagram of a network operating environment in accordance with an embodiment of the present invention; and

FIG. 3 is a process flow chart illustrating an example process according to one embodiment of the present disclosure.

Like reference numerals refer to like parts throughout the several views of the drawings.

### DETAILED DESCRIPTION

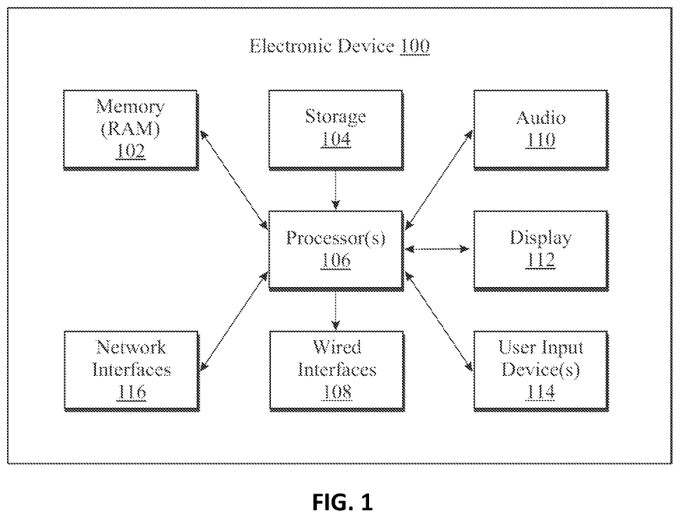

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”. “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Before the present invention is disclosed and described, it s to be understood that the terminology used herein is for the purpose of describing particular embodiments only and is not intended to be :limiting. The terms “a” or “an,” as used herein, are defined as one or more than one. The term “plurality,” as used herein, is defined as two or more than two. The term “coupled,” as used herein, is defined as connected, although not necessarily directly, and not necessarily mechanically.

The terms “program,” “application,” “software application,” “mobile application” and the like as used herein, are defined as a sequence of instructions designed for execution on a computer system. A “program,” “computer program,” “application,” or “software application” or “mobile application” may include a subroutine, a function, a procedure, an object method, an object implementation, an executable application, an applet, a servlet, a source code, an object code, a shared library/dynamic load library, and/or other sequence of instructions designed for execution on a computer system.

It is to be understood that the disclosed embodiments discussed herein are merely exemplary of the invention, which can be embodied in various forms. Moreover, the titles used herein are merely descriptive of the content contained, or figures described, therein. The present invention provides a novel and efficient system and method of providing relevant offers, specials, deals, etc. for services, repairs and maintenance services for a user's specific vehicle and/or specific vehicle characteristics (e.g., oil type, mate, model, year, etc.).

Some embodiments of the present invention are directed to a mobile application (or other software application) and/or a related system (e.g., server) configured to provide the offer information discussed herein. For example, in some embodiments, vehicle manufacturer dealerships service centers and/or independent companies (e.g., Jiffy Lube) may login/sign-in to the respective software applications (either mobile or desktop application) and provide their facility information address, phone, etc.) and information on their services (e.g., oil changes, etc.).

In some embodiments, consumers have a separate consumer software application (configured for consumers searching for offers to service their vehicles) and service providers have a separate service provider software application (configured to allow service providers to input new active offers and/or modify or delete existing offers), but all consumers and service providers may connect to the same database.

In some embodiments, when a consumer signs into and/or opens his/her mobile application, the user may input an email address and a profile name to be associated with his/her user account. In some embodiments, the consumer may then add vehicle information for one or more of their vehicles (e.g., select the vehicle make, model and year). In some embodiments, the consumer may further select an oil type for the vehicle (e.g., synthetic, etc.). In some embodiments, the mobile application may include a deals tab. When the consumer clicks on the deals tab, all the deals related to this user's vehicle may be viewable in the mobile application. In some embodiments, the mobile application populates offers from all service providers that provide that specific service within the mobile application. In some embodiments, the mobile application may present the different service providers either by e,g., a map view (pin locator) or a list view. In some embodiments, when the user selects a pin locator, the mobile application presents the service provider information (e.g,, name, address, etc.) and price for the vehicle service associated with the offer. In some embodiments, the service provider information may include facility information with driving directions. In some embodiments, the consumer may add multiple vehicles ire the mobile application and all the vehicles, and their respective information may be associated with the user's account. In further embodiments, the information provided to the consumer may include links to review websites and social media to facilitate review of the service provider by the consumer upon completion of the vehicle service.

In some embodiments, the mobile application and related system provided by the present invention does not require a wireless communication to the vehicle, In some embodiments, the mobile application and related system provided by the present invention may be configured to not require access to a vehicle service website. In some embodiments, the mobile application and related system provided by the present invention provides a vehicle owner with a link-less opportunity to be provided with offer information from independent and manufacturer service providers for vehicle services, such as repairs and maintenance, that the user desires to complete on their vehicle. In some embodiments, the mobile application and related system provided by the present invention does not initiate the offer to the consumer, the consumer initiates the services. In some embodiments, the mobile application and related system provided by the present invention displays services regardless of demographics, purchase history, or other filtering that is not requested by the consumer. In some embodiments, the mobile application and related system provided by the present invention provides offers that are displayed to the user when initiated by the user. In some embodiments, the mobile application and related system provided by the present invention is filtered or otherwise selected according to user-input information and lists only relevant offers based on such user-input selection information. In some embodiments, the mobile application and related system provided by the present invention displays information; however, it may not be required to accept the offered services. In some embodiments, the mobile application and related system provided by the present invention provides an on-line electronic marketplace for vehicle service offers. In some embodiments, the mobile application and related system provided by the present invention does not take payment for services, but rather advertises to the consumer the vehicle service offers relevant to the user's vehicle. In some embodiments, the mobile application and related system provided by the present invention does not limit service providers to vehicle manufacturers, also known as vehicle dealers. In some embodiments, the mobile application and related system provided by the present invention provides relevant offers for services for vehicle repairs and/or services and/or maintenance. In some embodiments, the mobile application and related system provided by the present invention provides consumers with offers (e.g., specials, deals, coupons, etc.) from independent service providers and manufacturer service facilities.

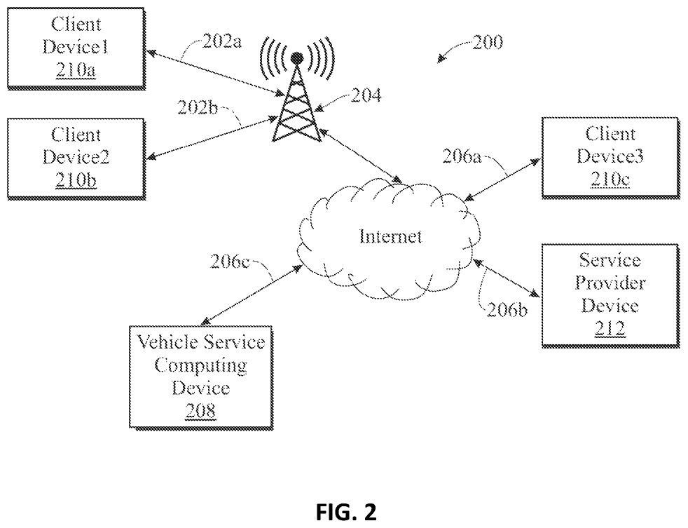

Although the process flowcharts described herein, such as FIG. 2, shows a specific order of executing the process steps, the order of executing the steps may be changed relative to the order shown in certain embodiments. Also, two or more blocks shown in succession may be executed concurrently or with partial concurrence in some embodiments. Certain steps may also be omitted for the sake of brevity.

Shown throughout the figures, the present invention is directed toward a method and system for coordinating a particular vehicle service activity at a particular time and location.

Electronic Device

An electronic device 100 in the exemplary form of a computer is illustrated in the schematic diagram in FIG. 1. It will be appreciated, however, that the exemplary context of the computer in FIG. 1 is not the only operational environment in which aspects of the disclosed systems and methods may be used. Therefore, the techniques described herein, may be applied to any type of one or more electronic devices 100, examples of which include, but are not limited to a server/computing device configured to perform one or more of the techniques disclosed herein, a mobile telephone/client device associated with a user and configured to perform one or more of the techniques disclosed herein, a personal computer (PC), a media player, a gaming device. a personal data assistant, a smartphone, a computer tablet, a smartwatch, or the like. The electronic device 100 can include one or more of: memory 102, a storage device 104, one or more processors 106, a wired interface 108, an audio input/output 110, a display 112, a user input device 114, and a network interface 116.

The processor 106, may be a central processing unit and/or a controller. The processor 106 may include integrated circuitry, firmware, Field Programmable Gate Arrays FPGAs), Application Specific Integrated Circuitry (ASIC) and/or other types of processing components configured to execute instructions according to one or more of the processes disclosed herein. The processor 106 may be configured to access (e.g., write to and/or read from) the memory 102, which may store software code and/or computer executable instructions to perform one or more of the processes disclosed herein. The memory 102 may include any kind of volatile and/or nonvolatile memory, such as, for example, RAM (Random Access Memory) and/or ROM (Read-Only Memory) and/or EPROM (Erasable Programmable Read-Only Memory) and/or a cache and/or buffer memory in the processor 106.

The electronic device 100 may use, for example, the network interface 1 l6 to communicate over wireless communication links and and/or the wired interface 108 to communicate over wired communication links. The user input device 114 may be any type of user input device, such as, for example, a touchscreen, a keyboard, a mouse, etc. The display 112 may be any type of computer or electronic display, such as, for example, a monitor, a touchscreen, an LED display, etc. The audio input/output 110 may be any type of audio input such as, for example, a microphone and/or a speaker.

Network

Referring to FIG. 2, there is illustrated a block diagram of an exemplary network operating environment 200 for the apparatuses and methods of the present invention. Various electronic devices are connected over a network. The electronic devices can be servers/computing device, personal computers, mobile cellular telephones, smart phones, computer tablets, servers, network nodes and the like.

The electronic devices may communicate via a wired (e.g., cable, phone line, and fiber optic) or wireless communication links 202a-b, such as radio waves that, may be transmitted and received over a network, such as a cellular network having a multitude of nodes, such as cellular towers 204 for receiving and transmitting radio signals over the network. The electronic devices and the cellular network may also communicate with other wide area networks (WAN), such as the Internet, via a communication link 206a-c that may be wired (e.g., cable, phone line, and fiber optic) and/or wireless (e.g., radio signals). Many other wired and wireless connections are known in the art and can be used with the present invention.

A vehicle service computing device 208 may be connected to a network, such as the Internet, for providing services to a client device 210, such as client devices 210a-c, and/or one or more service provider devices 212 (e.g., dealerships, manufacturers, independent vehicle service providers, etc.) according to the arrangements discussed herein. The vehicle service computing device 208, client device 210 and service provider device 212 may each include one or more of the hardware elements discussed with respect to the example electronic device in FIG. 1. The vehicle service computing device 208 may include, for example, a server that services requests via mobile apps running on such client devices 210. In some embodiments, the vehicle service computing device 208 may also receive requests made by service providers on their service provider devices 212, to, for example, add, remove and/or modify active offers provided by such service providers. The vehicle service computing device 208, service provider device 212 and/or client device 210 may be configured to perform one or more of the techniques and arrangements disclosed herein.

### EXAMPLE 1

### Process of Providing an Electronic Marketplace

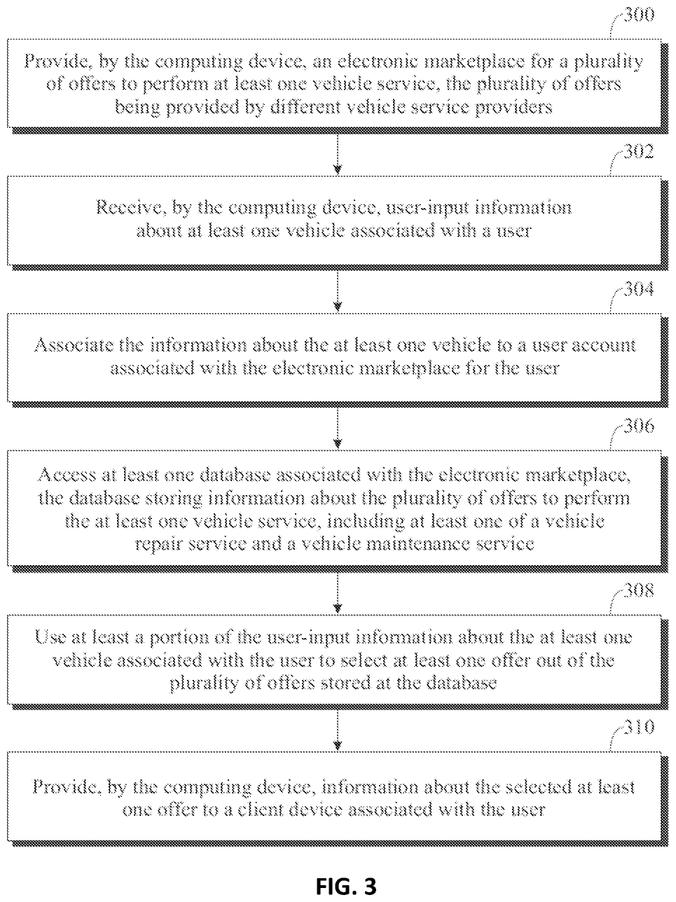

Referring now primarily to the process flow chart depicted in FIG. 3, an exemplary process for providing an electronic marketplace for vehicle services according to some embodiments of the present disclosure will be described.

Initially, a user may be required to download and install a mobile application on the user's client device 210 in order to receive the offers provided by the vehicle service computing device 208. The user may further create an account and a username and password and create a user profile, according to known arrangements for creating accounts. The mobile application may be considered a vehicle service application where each vehicle service application operating on a respective client device 210 is associated with a respective user.

In some embodiments, the mobile application may provide a graphical user interface and that allows users to input specific profile and vehicle information. For example, the mobile application may allow the client device 210 to input (e.g., selecting from drop-down menus, typing in a field of a graphical user interface, etc.) vehicle information. The vehicle service computing device 208 may then use the user-input vehicle information to filter or otherwise select offers from a database of vehicle service offers in order to present to the user at the user's client device 210 only the vehicle service offers relevant to the user-input vehicle information.

In some embodiments, the account types and user types associated with the mobile application and/or the vehicle service computing device 208 may be divided into two at least two different main user groups. For example, the vehicle service computing device 208 may provide for a group of first users and a group of second users. The group of first users may be a group of vehicle service users (consumers) that input vehicle information for their particular vehicles. Examples of first users include any individual seeking to view vehicle service offers (e.g., deals, coupons, special, rates, etc.) to perform vehicle services relevant to their particular-vehicle.

The group of second users may be a group of vehicle service providers whose user account is associated with users desiring to provide vehicle services to the group of the first users. Examples of second users are dealerships, independent mechanic shops, or other independent auto service providers that are willing to provide vehicle services to first users.

In step 300, the method may include providing, by the computing device 208, an electronic marketplace for a plurality of offers to perform at least one vehicle service.

The vehicle service may include vehicle maintenance tasks including, for example, oil changes, changing air filters, rotating tires, change of transmission fluid, replacing spark plugs, wheel alignment, etc. The vehicle service may include repair or replacement services, such as, for example, clutch replacement, windshield repair, engine repair, body work, etc.

The mobile application installed at the client device 210 and the computing device 208 (e.g., server) configured to filter/select/provide offers and service requests from the client device 210 may be considered to provide the electronic marketplace.

The term “offer” is used generally herein and may be used to indicate an offer by a service provider to perform a particular vehicle service, such as a deal, special, coupon, etc. The offer may include specific information about the terms of the offer, such as a cost of the vehicle service being offered or a discount (e.g., 20% off for all oil changes on Mondays) to be applied to the vehicle service and any other pertinent terms, such as, time limitation on the offer (e.g., expiration date), restrictions (e.g., 1 per customer), barcode or redemption code, address of the facility at which the vehicle service would be performed, contact information, etc.

The plurality of offers may be provided by different vehicle service providers. In other words, the at least one of the different vehicle service providers may be independent from at least one other of the different vehicle service providers. In some embodiments, the plurality of vehicle service providers may include a plurality of different service providers including at least one manufacturing service provider and at least one third-party service provider. The at least one third-party service provider may be considered independent from a vehicle manufacturer. For example, vehicle service providers may include manufacturers, dealerships, independent auto body shops, independent vehicle service providers, etc.

Thus, instead of the user having to search for offers across many disparate websites in order to find the best deal for a particular service, some embodiments of the present invention may allow the user to merely input information about the vehicle and the mobile app may then present all the offers from the database that are relevant to the service that they desire and/or the vehicle information. For example, the user may own a foreign vehicle (e.g., BMW); thus, the mobile application will present only the offers relevant to vehicle services that can be performed on a BMW, which generally requires, for example, a different type of oil change, as compared to other types of vehicles. In further embodiments, the service offers may be presented as available on the calendar day of inquiry. In further yet embodiments, the service offers may be provided on the day of inquiry as well as for a certain time thereafter, such as 1 day, 2 days, 3 days, 4 days, 5 days, 6 days, 1 week, 2 weeks, 3 weeks, 4 weeks after the calendar day of inquiry. In further embodiments, additional offers may be provided to the consumer on the same weekday as the calendar day of inquiry, for example for the next 1, 2, 3, 4, 5, or 6 weeks thereafter. Additional alert note may be provided to the consumer if a service offer for another day in the near future may be better than the service offer available for the calendar day of inquiry. In other embodiments, the user may only need to enter the VIN number for his/her vehicle, as the built-in database of most common vehicles can be used to automatically populate the specific vehicle tab with all pertinent information about this vehicle based on the VIN number.

In some embodiments, a different mobile application (or other software application) may be provided for the vehicle service providers. As with the mobile application for consumer users described above, the vehicle service provider mobile application may be downloaded and installed on an electronic device associated with an owner or employee of the vehicle service provider and then used to input service offer information (e.g., information about deals, coupons, specials, rates, images associated with the deal or coupon, etc.). Such offer information may be considered provider--input information.

In some embodiments, the process may include receiving, by the computing device 208, provider-input information from a client device 210 associated with a vehicle service provider. The provider-input information may include information about the vehicle service provider (e.g., name and address of the vehicle service provider, contact information such as telephone number and email address, etc.) and at least one vehicle service type (e.g., oil change, body work, diagnostic tests, repair, etc.) provided by the vehicle service provider. The process may further include storing, by the computing device 208, the provider-input information in at least one database associated with the electronic marketplace. The database may store all the offer information from different vehicle service providers.

For example, in some embodiments, the vehicle service provider may input information about which types of vehicles they service or specialize in, which types of services are provided, and also which types of vehicles are associated with each service. This may permit the vehicle service computing device 208 to match services to the type of vehicle (or vehicle specific information) that the user inputs at his/her mobile application. For example, a vehicle service provider may enter information that the provider performs oil changes using synthetic and synthetic blend motor oil and may further input offer information for performing synthetic oil changes at 20% off during the month of January. Thus, a user inputting synthetic oil as an oil type for his/her vehicle would be presented with this offer. On the other hand, a user inputting conventional motor oil as an oil type for his/her vehicle would not be presented with this offer since it would not apply to that user's vehicle.

In some embodiments, the vehicle service provider mobile application may include drop-down menus or other selectable options for otter information that is configured to be able to match to user-input vehicle information so that the vehicle service computing device 208 (e.g., server) may be able to filter out irrelevant options, or otherwise select relevant options efficiently. For example, continuing with the oil type example, the vehicle service provider mobile application may include a drop-down menu, checkbox, etc. (or other selectable GUI list) that provides a pre-defined list of all the different types of oils that may apply to a particular deal. Similarly, the vehicle owner's mobile application may include a drop-down menu, checkbox, etc. that provides the pre-defined list of all the different types of oils that may be used by vehicles, which the user can then select from for the specific vehicle. The predefined lists on both the user and service provider mobile applications may be the same, so that the vehicle service computing device 208 can efficiently filter out any offers that are specific to an oil type that the user did not select in the predefined list, or, alternatively fetch offers that that do include the oil type selected by the user. For example, relevant offers may be provided by word matching, such as, for example, the following pseudo code: Display.Offers=GetFromDB (var.oilType=“synthetic”); or Display.Offers=GetFromDB (var.oilType!=“conventional”).

It should be understood that there are many different ways of identifying/selecting relevant offers stored at the database based on the user-input vehicle information and the offer information provided by service providers and the examples described herein are for illustrative purposes.

It, should be understood that although some examples may discuss certain processing tasks as being performed by a server operating at the vehicle service computing device 208, in some embodiments, the processing tasks may be performed by a processor at the client device 210 operating the mobile application, rather than a remote server.

### EXAMPLE 2

### Process of Receiving Information About the User's Vehicle and Associating the Information to the User's Account

Referring still primarily to the process flow chart depicted in FIG. 3, an exemplary process for receiving user-input information about at least one vehicle associated with the user according to some embodiments of the present disclosure will be described.

In step 302, the method may include receiving user-input information about at least one vehicle associated with a user.

The vehicle service may include vehicle maintenance tasks including, for example, oil changes, changing air filters, rotating tires, transmission fluid change, replacing spark plugs, wheel alignment, etc. The vehicle service may include repair services, such as, for example, clutch replacement, windshield repair, engine repair, body work, etc.

In some embodiments, the user's mobile application may include drop-down menus, checkboxes, or other selectable options for vehicle information that is configured to be able to match to offer information so that relevant offers can be displayed to the user at the client device 210. In some embodiments, the user's mobile application may include selectable vehicle information, such as, for example, one or more of: a vehicle make drop-down menu, a vehicle model drop-down menu, a year drop-down menu, an oil type drop-down menu, etc. In some embodiments, the user's mobile application may include a drop-down menu (or other selectable GUI list) including a pre-determined list of vehicle services. The user may then select which vehicle services that user desires to receive offers for. Such user-selected vehicle information may be used to determine which offers in the database to display to the user. The vehicle service computing device 208 may be associated with (e.g., includes or is connected to) the database.

In step 304, the method may include associating the user-input information about the user's vehicle(s) to a user account associated with the electronic marketplace for the user. For example, the particular information input by a particular user may be associated with her/her user account and stored at, for example, a remote user database and/or at the user's client device 210. Thus, the user may not be required to perform a keyword search every time the user wants to find a good vehicle service deal; instead, the user may input the vehicle information once, where it is stored and used to determine which offers to display to the user by, for example, simply selecting which of the vehicles the user wants to find an offer for, which service and then selecting a deals tab within the mobile application that automatically populates with relevant offers associated with the vehicle information already associated to the user's account.

### EXAMPLE 3

### Process of Accessing and Filtering Offers in a Database Based on the User-Input Vehicle Information

Referring still primarily to the process flow chart depicted in FIG. 3, an exemplary process for accessing the database and filtering offers based on the vehicle information according to some embodiments of the present disclosure will be described.

In step 306, the method includes accessing at least one database associated with the electronic marketplace. The database may store information about the plurality of offers to perform vehicle services. The vehicle services may include, for example, vehicle repair services and vehicle maintenance services.

In some embodiments, the database may be stored in a memory at the user's client device 210. In some embodiments, the database may be a remote database. In some embodiments, the database may be stored in a memory at the vehicle service computing device 208.

In step 308, the method includes using at least a portion of the user-input information about the vehicle associated with the user to select at least one offer out of the plurality of offers stored at the database.

In some embodiments, offers out of the plurality of offers stored at the database may be selected based on one or more of the user-input vehicle information.

In some embodiments, all of the user-input vehicle information may be used to select which offers to display to the consumer. In some embodiments, the mobile application may allow users to select which of the user-input vehicle information the user desires to use to select or filter offers with. For example, users that want service providers that specialize in their make of vehicle (e.g., BMW) may select to use the vehicle make information to select/filter offers. However, users that are not concerned with the service provider specializing in the make of their vehicle may not select vehicle make information as a criteria for selecting/filtering offers. In some embodiments, the user may select which service providers they want to be displayed offers from. Other user-selectable options may include, for example, cost, discount, time limitations, etc. associated with offers. Yet, other user-selectable options may include, for example, ratings for service providers, either from other users associated with the vehicle service mobile application and/or general ratings such as Better Business Bureau (BBB) or social media ratings.

Thus, some embodiments may provide for receiving a user-selected subset of the user-input information, the user-selected subset being used to determine which of the plurality of offers to be selected and displayed at the user's client device 210.

In some embodiments, the vehicle service computing device 208 may be configured to select or filter out a sub-set of the offer information based on a location associated with the user, e.g., GPS location of the client device 210, user-input location information (e.g., zip code, city, physical address, etc.). Thus, offers from vehicle service providers that are not within a predetermined proximity (e.g., 25 miles, 50 miles, etc.) may not be displayed to the user. In some embodiments, the mobile application may be configured with a default proximity parameter (e.g., 50 miles). In some embodiments, the user may be allowed to input/select a desired proximity limitation.

### EXAMPLE 4

### Process of Providing Offers to the Client Device

Referring still primarily to the process flow chart depicted in FIG. 3, an example process for providers offers to the user according to some embodiments of the present disclosure will be described.

In step 306, the method includes providing information about the selected offers to the client device 210 associated with the user.

The information provided about the offer may include, for example, specific information about the terms of the offer, such as a cost of the vehicle service being offered or a discount (e.g., 20% off for all oil changes on Mondays) to be applied to the vehicle service and any other pertinent terms, such as, time limitation on the offer (e.g., expiration date), restrictions (e.g., 1 per customer), barcode or redemption code, address of the facility at which the vehicle service would be performed, contact information, etc.

Such information may be displayed at the user's client device 210 and may include text-based information and/or graphical image-based information, such as, a flyer or coupon. In some embodiments, the offer information may be displayed in a list format within the mobile application, where each offer may be selectable by the user to he able to see more details about the offer.

In some embodiments, the offer information may be displayed in a map view (e.g., including a plurality of pin locators for each service provider physical address). The pin locator may show the service provider's name and price/cost for the service being offered. The pin locator may include a link to driving directions to the service provider's physical address. In some embodiments, the offer information may include contact information, such as, for example, a telephone number and email address. In some embodiments, the offer information may include a hyperlink that, is clickable to automatically call the service provider and/or email the service provider. In further embodiments, a link to arrange for the service may be provided, wherein clicking on the link will cause making an appointment for selected service in a single step. In yet other embodiments, the offer information may be displayed and/or presented at the user's client device 210 in other ways.

In some embodiments, the mobile application may not provide an electronic payment arrangement feature and may be configured to merely present relevant offers to the user and allow the user to initiate contact with the vehicle service provider independently from the mobile application. In alternative embodiments, an automatic scheduling and/or electronic payment arrangement feature may be provided, which is advantageous in facilitating a touchless receipt of vehicle services by the consumer.

Alternative embodiments are contemplated in addition to the embodiments shown and/or described herein, which are exemplary. For example, in at least some alternative embodiments, the method may further include a step of storing the vehicle maintenance and/or repair records. Information for the vehicle record may be automatically recorded from the record of completed. vehicle service requests and/or uploaded by the consumer based on other vehicle services conducted in the past or with service providers outside the network of the present invention. In further alternative embodiments, the method may include a step of generating automated reminders about upcoming vehicle service events that can be recommended to the consumer. Such reminders may be accompanied by a list of offers for the corresponding service from local service providers, optionally ranked by previous record of servicing the same vehicle, rating given by the consumer, geographical distance, cost of service, or using other ranking approaches as specified by the consumer and/or the network administrator.

In some embodiments the method or methods described above may be executed or carried out by a computing device including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or :logic processing devices. For example, the logic machine may be configured to execute instructions to perform tasks for a computer program. The logic machine may include one or more processors to execute the machine-readable instructions. The computing device may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing device may include an input subsystem that receives user input. The input subsystem may be configured to connect to and receive input from devices such as a mouse, keyboard or gaming controller. For example, a user input may indicate a request that certain task is to be executed by the computing device, such as requesting the computing device to display any of the above-described information or requesting that the user input updates or modifies existing stored information for processing. A communication subsystem may allow the methods described above to be executed or provided over a computer network. For example, the communication subsystem may be configured to enable the computing device to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A method implemented in a computing device, the method comprising the following steps:
(a) providing, by the computing device, an electronic marketplace for a plurality of offers to perform at least one vehicle service, the plurality of offers being provided by different vehicle service providers;
(b) receiving, by the computing device, user-input information about at east one vehicle associated with a consumer;
(c) associating the information about the at least one vehicle to a user account associated. with the consumer in the electronic marketplace;
(d) accessing at least one database associated with the electronic marketplace, the database storing information about the plurality of offers to perform the at least one vehicle service, the at least one vehicle service including at least one of a vehicle repair service or a vehicle maintenance service;
e) using at least a portion of the user-input information about the at least one vehicle associated with the consumer to select at least one offer out of the plurality of offers stored at the database; and
(f) providing, by the computing device, information about the selected at least one offer to a client device associated with the consumer.

2. The method as in claim 1, wherein step (b) further comprising establishing a consumer user account prior to providing user-input information about the at least one vehicle associated therewith.

3. The method as in claim 1, wherein in step (e) the at least one offer is selected only from offers suitable for the specific vehicle associated with the consumer.

4. The method as in claim 1, wherein in step (e) more than one offer is selected and in step (f) more than one offer is provided to the consumer, wherein all selected offers are provided to the consumer are suitable for the vehicle associated therewith.

5. The method as in claim 1, wherein step (e) further comprising providing at least one filter to the consumer to sort through the plurality of offers to perform the at least one vehicle service.

6. The method as in claim 1, wherein step (e) further including filtering the plurality of offers based on a calendar day of inquiry.

7. The method as in claim 6, wherein in step (e) the filtering includes additional days up to 4 weeks from the calendar day of inquiry.

8. The method as in claim 7, wherein the filtering includes only the same day of the week as the calendar day of inquiry.

9. The method as in claim 1, wherein in step (c) the information about the at least one vehicle comprises a VIN (vehicle identification number), and wherein the computing device is further configured to retrieve additional vehicle information based on the entered VIN.

10. The method as in claim 1, wherein in step (a) the vehicle service providers include at least one vehicle manufacturer dealerships service center.

11. The method as in claim 1, wherein in step (a) the vehicle service providers include at least one independent vehicle service provider.

12. The method as in claim 1, wherein in step (b) more than one vehicle is associated with the same consumer user account.

13. The method as in claim 1, wherein in step (f) the information about one or more selected offers is provided to the consumer on a geographical map or as a list.

14. The method as in claim 13, wherein in step (f) the information about one or more selected offers provided to the consumer is accompanied by driving directions to respective service provides.

15. The method as in claim 1, wherein is step (d) the information about the plurality of offers includes regular offers of vehicle service without an expiration date and special offers of vehicle service with an expiration date associated therewith.

16. The method as in claim 1, wherein in step (a) the plurality of offers include at least one offer comprising at least one term of the offer.

17. The method as in claim 16, wherein the at least one offer comprising at least one of the following: information indicating a name of the vehicle service provider, a cost for the vehicle service, a time limitation associated with the offer, a code associated with redeeming the offer with the vehicle service provider, a physical address and contact information associated with the vehicle service provider.

18. The method as in claim 1, wherein the step (e) further including a step of matching provider-input offer information to user-input vehicle information.

9. The method as in claim 1, wherein in step (f) the information about the selected at least one offer is accompanied by at least one link to a review website or social media, whereby facilitating reviewing of the service provider by the consumer upon completion of the selected vehicle service.

20. The method as in claim 1, wherein in step (0 the computing device is further configured to facilitate scheduling of and payment for the selected vehicle service, whereby facilitating touchless receipt of the vehicle service by the consumer.
